(19) United States
(12) Patent Application Publication
(10) Pub. No.: US 2026/0169295 A1
(43) Pub. Date: Jun. 18, 2026

(54) DEPOLARIZING PRISM OPTICAL SYSTEM FOR EFFICIENT WAVEGUIDE INJECTION IN HEAD-WEARABLE DISPLAYS

(71) Applicant: GOOGLE LLC, Mountain View, CA (US)

(72) Inventor: Thomas Hoekman, Redwood City, CA (US)

(21) Appl. No.: 19/422,843

(22) Filed: Dec. 17, 2025

Related U.S. Application Data
(60) Provisional application No. 63/735,139, filed on Dec. 17, 2024.

(51) Int. Cl. G02B 27/01; G02B 27/28

(52) U.S. Cl. CPC G02B 27/0172; G02B 27/283; G02B 2027/011; G02B 2027/0118; G02B 2027/0178

(57) ABSTRACT

Optical assemblies and display systems condition display light prior to injection into a waveguide of a head-wearable or near-eye display device. A prism assembly includes multiple internal surfaces bearing reflective and polarization-dependent beam-splitting coatings, and a polarization-conversion layer positioned such that display light propagating within the prism passes through the polarization-conversion layer between multiple interactions with the coatings. These interactions facilitate polarization mixing, spatial redistribution, or footprint shaping of the display light to improve compatibility with thin waveguide input couplers. In at least some embodiments, the prism assembly further includes angled entrance and exit surfaces that redirect the propagation direction of the conditioned display light to support compact optical routing or binocular alignment. The conditioned display light is then coupled into a waveguide for guided propagation and output toward the eye of a user.

### BACKGROUND

Head-wearable displays (HWDs) and other near-eye display (NED) systems commonly utilize compact projection engines to deliver image light into an optical combiner or waveguide element. Such systems often employ micro-scale image sources, including liquid crystal on silicon (LCoS) panels, micro-light emitting diode (microLED) arrays, and laser beam scanning (LBS) modules, that produce collimated or partially collimated light suitable for optical injection. The projection optics associated with these image sources typically incorporate polarization-manipulating components such as polarizing beam splitters, waveplates, reflective coatings, and fold prisms to separate illumination and imaging paths and to condition the polarization state of the emitted light.

Waveguide-based display elements in HWDs and NEDs often include diffractive or holographic input couplers, exit pupil expanders, and output couplers that guide injected display light by total internal reflection and redirect the guided light toward the eye of a user. The geometry, configuration, and optical characteristics of these couplers influence coupling efficiency, uniformity, and the spatial distribution of the injected light. In many implementations, the size and shape of the display-light footprint at the input coupler are influenced by the etendue of the projection engine, the emission behavior of the microdisplay, and the optical properties of upstream polarization-sensitive components.

Various optical architectures have been developed to improve the compactness, efficiency, and manufacturability of projection engines for head-worn and near-eye display systems. These architectures may incorporate folded optical paths, prism assemblies with parallel or angled surfaces, internal beam-steering elements, polarization-conversion layers, and combinations of reflective or polarization-selective coatings. Such systems are frequently configured to interface with thin waveguides that support a limited range of input geometries dictated by their diffractive features and total internal reflection constraints.

As head-wearable and near-eye display technology continues to evolve, ongoing development of projection-optical configurations remains an active area of interest, particularly with respect to efficiently coupling image light into waveguide combiners, accommodating compact mechanical form factors, and maintaining compatibility with various microdisplay technologies and polarization states.

### SUMMARY OF EMBODIMENTS

In accordance with one aspect, a prism assembly includes a prism having a plurality of internal surfaces including a first internal surface and a second internal surface; a reflective coating disposed on the first internal surface; a polarization beam-splitting coating disposed on the second internal surface; and a polarization-conversion layer disposed within or adjacent to the prism such that display light propagating within the prism passes through the polarization-conversion layer prior to interacting with the polarization beam-splitting coating.

In some embodiments, the first internal surface and the second internal surface are substantially parallel to one another.

In some embodiments, the polarization-conversion layer comprises a waveplate.

In some embodiments, the reflective coating comprises at least one of: a metallic mirror coating; a dielectric mirror coating; or a polarization-selective reflective coating.

In some embodiments, the polarization beam-splitting coating is configured to transmit one polarization component of the display light and reflect at least a portion of an orthogonal polarization component.

In some embodiments, the prism assembly further includes an entrance surface and an exit surface through which the display light respectively enters and exits the prism.

In some embodiments, the entrance surface and the exit surface are oriented relative to the internal surfaces such that display light exiting the prism is redirected along a different propagation direction than display light entering the prism.

In some embodiments, the prism is configured to cause display light propagating within the prism to undergo repeated internal passes between the first internal surface and the second internal surface.

In some embodiments, the prism is configured such that the repeated internal passes of the display light within the prism cause polarization mixing or spatial redistribution of the display light.

In accordance with another aspect, a display system includes an illumination module configured to generate display light; a waveguide; and an optical system positioned between the illumination module and the waveguide, the optical system including: a prism assembly having a plurality of internal surfaces, including a first internal surface and a second internal surface; a reflective coating disposed on the first internal surface; a polarization beam-splitting coating disposed on the second internal surface; and a polarization-conversion layer disposed within or adjacent to the prism assembly such that display light propagating within the prism assembly passes through the polarization-conversion layer prior to interacting with the polarization beam-splitting coating, wherein the prism assembly is configured to direct the display light toward the waveguide.

In some embodiments, the prism assembly further comprises an entrance surface through which the display light enters the prism assembly and an exit surface through which conditioned display light exits the prism assembly.

In some embodiments, the first internal surface and the second internal surface of the prism assembly are substantially parallel to one another.

In some embodiments, the polarization-conversion layer comprises a waveplate.

In some embodiments, the reflective coating comprises at least one of: a metallic mirror coating; a dielectric mirror coating; or a polarization-selective reflective coating.

In some embodiments, the polarization beam-splitting coating is configured to transmit one polarization component of the display light and reflect at least a portion of an orthogonal polarization component.

In some embodiments, the prism assembly comprises an entrance surface and an exit surface through which the display light respectively enters and exits the prism assembly.

In some embodiments, the entrance surface and the exit surface are oriented relative to the internal surfaces such that display light exiting the prism assembly is redirected along a different propagation direction than display light entering the prism assembly.

In some embodiments, the prism assembly is configured to cause display light propagating within the prism assembly to undergo repeated internal passes between the first internal surface and the second internal surface.

In some embodiments, the prism assembly is configured such that the repeated internal passes of the display light within the prism assembly cause polarization mixing or spatial redistribution of the display light.

In accordance with a further aspect, a method of operating a display system, includes generating display light using an illumination module; directing the display light toward a prism assembly having a plurality of internal surfaces including a first internal surface with a reflective coating, a second internal surface with a polarization beam-splitting coating, and a polarization-conversion layer disposed within or adjacent to the prism assembly; propagating the display light within the prism assembly such that the display light interacts with the reflective coating and the polarization beam-splitting coating and passes through the polarization-conversion layer; and coupling conditioned display light from the prism assembly into an input coupler of a waveguide.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram illustrating an example diffractive waveguide and representative light paths exhibiting direct coupling and rebounce behavior.

FIG. 2 is a diagram illustrating an example visualization of input-coupler regions corresponding to different numbers of rebounce events for incident display light.

FIG. 3 illustrates an example head-wearable or near-eye display system configured to include a projection assembly and a waveguide combiner in accordance with some embodiments.

FIG. 4 illustrates a cross-sectional view of an example lens element that includes a diffractive waveguide having an input coupler, an exit-pupil expander, and an output coupler in accordance with some embodiments.

FIG. 5 illustrates an example optical system configured to condition modulated display light prior to waveguide injection in accordance with some embodiments.

FIG. 6 illustrates an example turning-prism configuration of the prism assembly of FIG. 5 configured to redirect conditioned display light toward a desired propagation direction in accordance with some embodiments.

FIG. 7 illustrates a flow diagram of an example method for conditioning display light prior to injection into a waveguide combiner in accordance with some embodiments.

### DETAILED DESCRIPTION

As described above, head-wearable displays (HWDs) and other near-eye display (NED) systems frequently employ diffractive or holographic waveguides to route image-bearing light from a compact projection source to the eye of a user. These waveguides typically incorporate an input coupler, such as a diffractive grating structure, which receives display light and injects it into a thin substrate where the light is guided by total internal reflection (TIR). Once inside the substrate, the light propagates toward downstream optical structures, such as exit pupil expanders and output couplers, which redirect the guided light toward the user's eye. The efficiency and uniformity of this process depend not only on the design of the diffractive structures but also on the spatial extent, angular distribution, and polarization state of the light delivered by the projection engine.

Projection engines used in HWDs and NEDs often include micro-light emitting diode (microLED) displays, liquid crystal on silicon (LCoS) panels, or laser beam scanning (LBS) modules, each of which produces a finite exit pupil. For many such systems, the exit pupil diameter is on the order of, for example, 1.5-5.0 millimeters. This diameter is influenced by the dimensions of the underlying display panel, the characteristics of backlight or illumination optics, and the presence of polarization-managing components such as polarizing beam splitter (PBS) cubes. Although a smaller exit pupil may more closely match the thin geometry of a waveguide input coupler, reductions in pupil size are limited by etendue constraints, which restrict how much the spatial and angular distribution of light can be compressed without reducing throughput. As a result, the beam footprint projected onto the input coupler is often considerably larger than the thickness of a typical waveguide substrate, which may be only, for example, 0.5-1.0 millimeters.

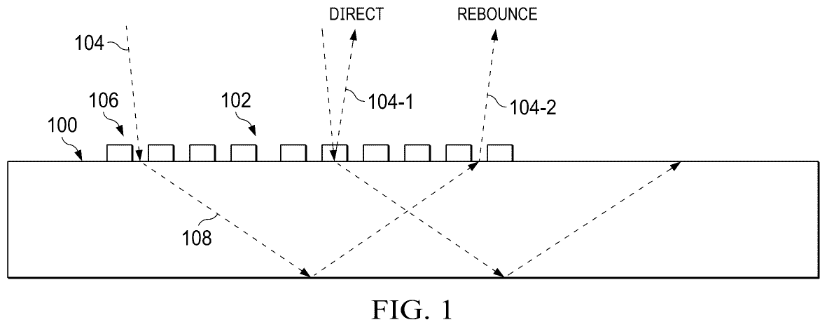

When a relatively large beam footprint illuminates a thin diffractive input coupler, the injected light may encounter substantial nonuniformity in coupling efficiency. FIG. 1 illustrates an example configuration of a waveguide 100 that includes a set of input-coupler grating features 102 on a surface of the substrate. As shown, incident display light 104 arriving at the incoupling edge 106 of the grating may be diffracted efficiently into the waveguide 100. Once inside the waveguide 100, a portion of the light follows a path determined by the TIR boundary conditions of the substrate. Some of this guided light exits the input-coupler region directly, as indicated by the “direct” rays 104-1 in FIG. 1. However, other portions undergo one or more internal reflections and subsequently re-encounter the input coupler, producing what is referred to as rebounce, as indicated by the “rebounce” rays 104-2. Rebounce occurs when light initially diffracted into the waveguide encounters the input coupler again after one or more TIR reflections and is then partially extracted or redirected toward unintended directions, including back toward the projection engine. Each such rebounce interaction leads to optical loss, stray reflections, and spatial nonuniformity in the guided light distribution.

FIG. 1 further illustrates that the magnitude of rebounce depends on the region of the input coupler illuminated by the incident beam footprint. The incoupling edge 106 of the grating features 102 tends to be most efficient, since light entering near this boundary can be diffracted into the waveguide with minimal opportunities for repeated interactions. In contrast, incident light that arrives at regions farther from this edge may be diffracted into paths that re-intercept the input coupler after one or more reflections, increasing the likelihood of extraction or scattering. This effect is exacerbated when the beam footprint substantially exceeds the physical height of the waveguide substrate.

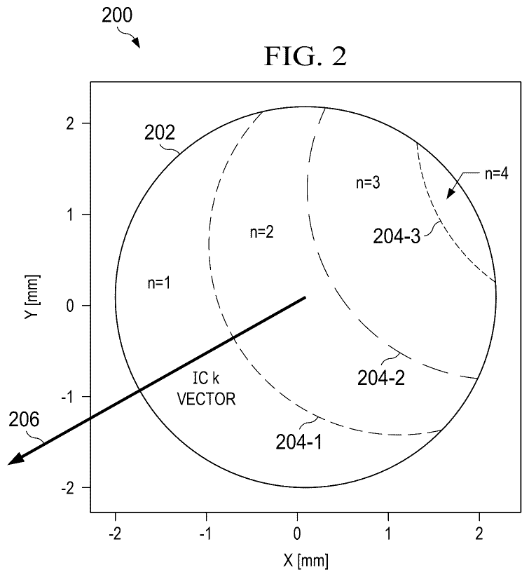

FIG. 2 provides an illustrative map 200 of regions within an input-coupler footprint that correspond to different numbers of rebounce interactions. In the example shown, the circular footprint 202 represents an idealized projection of the incident beam onto the coupler surface, while the curves 204 (illustrated as curve 204-1 to 204-3) identify boundaries between regions in which the light undergoes n=1, n=2, n=3, or n=4 rebounce events before reaching an output region of the waveguide. As depicted, only a limited portion of the footprint corresponds to the most desirable n=1 region, while substantial portions fall into higher-order rebounce regions. Light entering these regions is more likely to undergo multiple internal interactions, increasing losses and decreasing uniformity. The arrow 206 indicates the direction of the grating's reciprocal lattice vector (k-vector), which defines the effective incoupling orientation of the grating structure. The distribution of rebounce regions relative to this vector illustrates how the grating orientation and footprint geometry jointly influence coupling performance.

As FIG. 2 demonstrates, it is possible for a large fraction of a circular input-coupler footprint to correspond to higher-order rebounce zones, particularly when the footprint is large relative to the waveguide thickness. In such cases, only a subset of the illuminated area contributes efficiently to guided propagation, while the remainder gives rise to loss mechanisms that reduce brightness and degrade display uniformity. These factors contribute to increased optical inefficiency, as the projection engine must supply more optical power to compensate for the cumulative losses occurring during repeated coupler interactions.

In addition to the spatial considerations described above, polarization also plays a role in coupling behavior. Many microdisplay-based projection engines produce light with a well-defined polarization state due to PBS-based illumination paths or inherent characteristics of the microdisplay. Diffractive input couplers typically respond differently to s-polarized and p-polarized light, and this polarization dependence can amplify spatial coupling nonuniformity when the incident light is strongly polarized. Variations in polarization introduced by coatings, reflections, or mechanical alignment tolerances upstream of the coupler can further influence the distribution of injected light. These combined spatial and polarization effects underscore the complexity of achieving uniform, efficient coupling when the input beam footprint is large relative to the waveguide geometry.

Taken together, the size of the display-light footprint relative to the waveguide thickness, the etendue limits imposed by the underlying projection engine, the polarization characteristics of the emitted light, and the spatially varying behavior of diffractive input couplers collectively introduce coupling inefficiencies in head-wearable and near-eye display systems. These combined effects can lead to uneven light injection, increased sensitivity to illumination geometry, and optical losses arising from multiple rebounce interactions and polarization-dependent coupling behavior.

To address these and related challenges, the present disclosure describes optical assemblies configured to modify display light prior to injection into a waveguide of a head-wearable or near-eye display system. The disclosed techniques utilize prism-based optical structures to manipulate polarization state, spatial footprint, and beam geometry in a manner compatible with compact projection engines and thin waveguide couplers.

In various embodiments, an optical projection system includes a prism having one or more surfaces coated with reflective or polarization-selective layers, together with a polarization-conversion element such as a half-wave plate. The prism is positioned between a microdisplay-based light source and an input coupler of a waveguide and is configured to alter how display light propagates through the assembly, including directing portions of the light along different optical paths based on polarization.

In at least some embodiments, the prism incorporates parallel or angled surfaces that support multiple internal interactions of the display light. These interactions provide polarization mixing, spatial redistribution, footprint shaping, or beam-direction adjustments suited to the geometry and thickness of a waveguide substrate. The prism, in at least some embodiments, further includes entrance and exit surfaces oriented to steer the chief ray angle, support binocular alignment, or facilitate compact mechanical packaging within a head-worn device. The assemblies and configurations described herein may be implemented with a range of microdisplay technologies, including LCoS, microLED, and LBS light sources, and may be adapted for different waveguide architectures and device form factors used in head-wearable and near-eye display systems.

As such, the prism-based optical assemblies described herein can provide several technical effects in head-wearable and near-eye display systems. By conditioning display light prior to waveguide injection, the assemblies can promote more uniform interaction with diffractive input couplers and can help mitigate artifacts associated with polarization-dependent coupling behavior. The ability to redistribute or compress the spatial footprint of the display light can enhance compatibility with thin waveguide substrates and may reduce undesirable light interactions that occur during internal guiding. Adjustments to chief ray angle or beam geometry provided by angled prism surfaces can further support compact device integration and alignment flexibility. These collective characteristics contribute to improved optical efficiency, enhanced uniformity, and more versatile projection-engine architectures suitable for a wide range of wearable display implementations.

In the following description, certain orientational terms, such as top, bottom, front, back, inward, outward, and the like, are used in a relative sense to describe positional relationships among optical components of the display system. These terms are intended to be interpreted in relation to the drawings and to conventional optical layouts, rather than as absolute references to gravity, head position, or any external frame of reference. References to major and minor surfaces of optical elements, including waveguide surfaces, prism faces, or beam-splitting interfaces, should be understood in the context of their functional roles within the optical path and may be exaggerated or simplified for illustrative clarity. Additionally, for purposes of illustration, the figures are not necessarily drawn to scale, and the proportions of certain features, such as optical coatings, diffractive structures, or ray-path spacing, may be enlarged or reduced relative to other components to facilitate understanding. Moreover, the terms “contact”, “contacts”, or “contacting” refer to optical adjacency or coupling between components, and should be understood to encompass both direct physical contact and indirect coupling through intermediate optical materials or air gaps, unless the context clearly indicates otherwise.

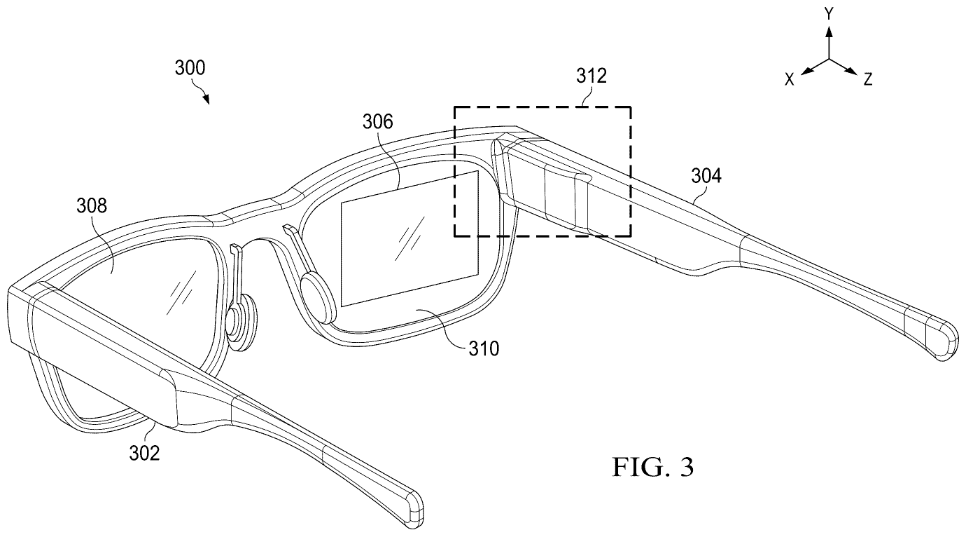

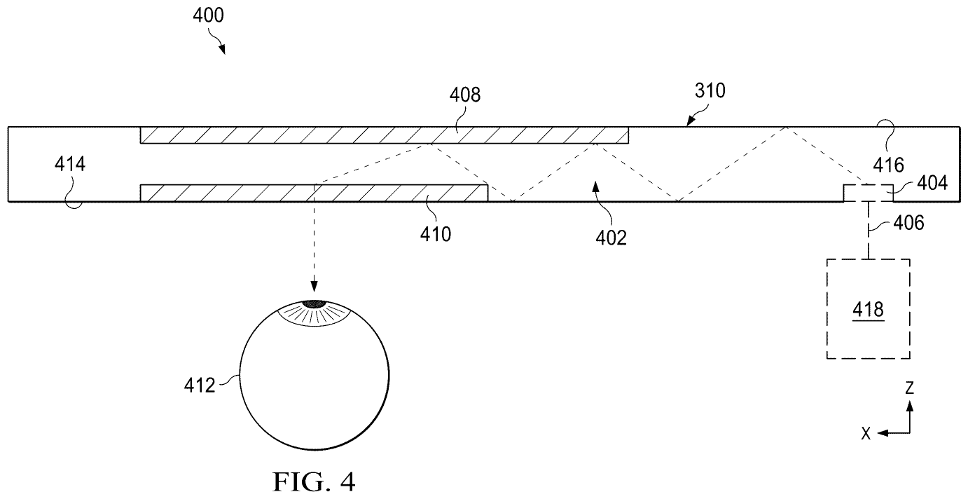

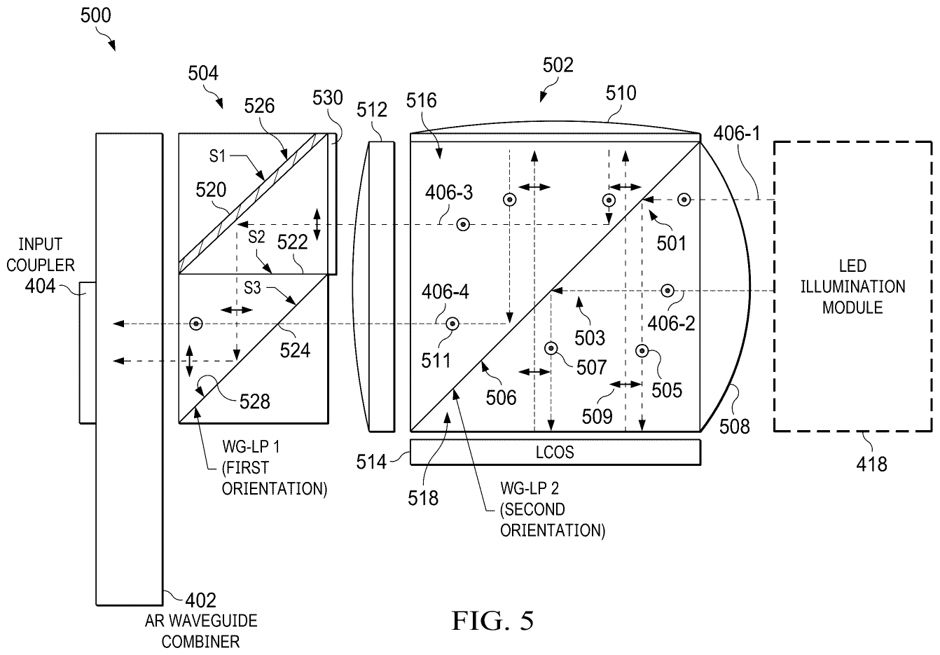

FIG. 3 illustrates a display system 300, such as a head-wearable display (HWD) or other near-eye display (NED), utilizing projected display light that may be depolarized or otherwise conditioned to reduce an output beam footprint, according to some embodiments. The display system 300 includes a support structure 302 (e.g., a support frame) that allows a user to wear the display system 300 on their head. The support structure 302 includes an arm 304 that houses an optical system made up of a projector display (e.g., a microLED, LCoS, or LBS projector) and projection optics (e.g., lenses, mirrors, and fold elements, shown in more detail below with reference to FIGS. 4 and 5) configured to project display light representative of images toward the eye of a user along a preconfigured optical path. As also described below, in some instances, the projection optics are also configured to depolarize the polarized light from the projector system in a manner that, when operated upon by the projection optics, reduces the output beam footprint, which in turn reduces the potential for rebounce.

The user perceives the projected display light as a sequence of images displayed in a field of view (FOV) area 306 at one or both of lens elements 308, 310 supported by the support structure 302. In some embodiments, the support structure 302 further includes various sensors (not shown in FIG. 3 for clarity), such as one or more front-facing cameras, rear-facing cameras, other light sensors, motion sensors, accelerometers, and the like. The support structure 302 can also include one or more radio-frequency (RF) interfaces or other wireless interfaces (not shown in FIG. 3 for clarity), such as a Bluetooth interface, a Wi-Fi interface, and the like.

At least some embodiments of the support structure 302 include one or more batteries or other portable power sources for supplying power to the electrical components of the display system 300. Some or all of these components of the display system 300 are fully or partially contained within an inner volume of the support structure 302, such as within the arm 304 in region 312 of the support structure 302. The illustrated embodiment of the display system 300 utilizes a form factor associated with spectacles or eyeglasses. However, the display system 300 is not limited to this form factor and can have a different shape and appearance from the eyeglasses frame depicted in FIG. 3.

One or both of the lens elements 308, 310 are used by the display system 300 to provide a display that renders graphical content that is superimposed over (or otherwise provided in conjunction with) a real-world view as perceived by the user through the lens elements 308, 310. For example, display light from the projector can be used to form a perceptible image or series of images that are projected onto the eye of the user via one or more optical elements, including a waveguide, formed at least partially in the corresponding lens element. In that case, one or both of the lens elements 308, 310 include at least a portion of a waveguide (e.g., a diffractive waveguide) that routes display light received by an incoupler (IC) (not shown in FIG. 3 for clarity) of the waveguide to an outcoupler (OC) (not shown in FIG. 3 for clarity) of the waveguide, which outputs the display light toward the eye of the user. Additionally, the waveguide can employ an exit pupil expander (EPE) in the light path between the IC and OC, or in combination with the OC, to increase the dimensions of the display exit pupil. Moreover, each of the lens elements 308, 310 is sufficiently transparent to allow the user to see through the lens elements to provide a field of view of the user's real-world environment such that the image appears superimposed over at least a portion of the real-world environment.

FIG. 4 depicts a cross-sectional view 400 of an implementation of a lens element that includes a waveguide 402, according to some embodiments. The lens element shown in FIG. 4 can be used to implement some embodiments of the lens element 310 of the display system 300 shown in FIG. 3. For purposes of illustration, at least some dimensions in the Z-direction are exaggerated for improved visibility of the represented structures. The illustrated embodiment of the waveguide 402 is a diffractive waveguide that includes diffractive optical structures configured to control the display light that enters, propagates through, and exits the waveguide 402. For reference, opposite sides of the waveguide 402 are referred to as an eye-facing side 414 and a world-facing side 416. Two regions 404 and 410 of diffractive optical structures are provided on the eye-facing side 414. The diffractive optical structures of region 404 are configured to function as at least a portion of an incoupler for display light 406 received from an illumination module 418, such as a light source or projector. The diffractive optical structures of region 410 are configured to function as at least a portion of an outcoupler for the display light 406 traveling through the waveguide 402. Diffractive optical structures of region 408 on the world-facing side 416 of the waveguide 402 are configured to provide exit-pupil-expander (EPE) functionality, enabling expansion of the displayed pupil to increase the effective eyebox size.

The illumination module 418 generates the display light 406 representative of a plurality of pixels and may be implemented using, for example, a microLED, LCoS, or LBS projector. The diffractive optical structures in region 404, together with any additional optical components upstream of the waveguide, incouple the display light 406 into the waveguide 402. Once incoupled, the display light 406 propagates within the waveguide through total internal reflection (TIR) toward the region 408, where the diffractive optical structures of region 408 diffract the light to perform exit pupil expansion. The expanded light then propagates to the diffractive optical structures of region 410, which output the expanded display light toward the user's eye 412 to form a perceivable image. In at least some embodiments, the positions of regions 408 and 410 may be reversed, with the diffractive optical structures of region 410 formed on the world-facing side 416 and the diffractive optical structures of region 408 formed on the eye-facing side 414. Such an arrangement may result in the regions 408 and 410 having different positions, dimensions, or shapes, and may require the diffractive optical structures in each region to have different characteristics.

As further shown in FIG. 4, the waveguide 402 is formed to be sufficiently transparent to allow the user to view the external environment through the lens element 310, enabling the display light 406 to appear superimposed on at least a portion of the real-world scene. In at least some embodiments, additional optical layers, coatings, or surface treatments may be applied to one or more surfaces of the waveguide 402 to reduce reflections, minimize ghosting or scattering, or otherwise improve perceived image quality. Such surface treatments may include, for example, anti-reflective coatings or index-matched layers.

In at least some embodiments, one or more additional optical elements may be positioned upstream of the incoupler region 404, such as fold mirrors or turning prisms, to route or align the display light 406 into the waveguide 402 along a target optical path. These optical elements may provide mechanical flexibility in arranging the illumination module 418 within a compact head-worn form factor and may also help ensure that the display light 406 enters the incoupler region 404 with a spatial and angular distribution suitable for efficient waveguide propagation.

As described above, waveguide-based display elements used in head-wearable and near-eye display systems rely on a sequence of diffractive optical structures to guide image-bearing light from an input coupler into the body of the waveguide, expand the display pupil through exit-pupil-expander elements, and ultimately direct the expanded display light toward an output coupler for viewing by the user. These waveguide architectures often operate within substrates that are only a fraction of a millimeter thick, requiring that injected display light enter the waveguide within a narrow spatial region and with an angular distribution compatible with total internal reflection. The interactions among the input coupler, the EPE region, and the output coupler, therefore, depend heavily on the spatial footprint and polarization characteristics of the incident display light delivered by the projection optics.

Projection systems used in near-eye displays commonly include microdisplay panels or laser-based scanners that produce a finite exit pupil, resulting in a beam footprint that may be significantly larger than the physical height of the waveguide substrate. When such a beam illuminates the input-coupler region of a thin waveguide, portions of the light may undergo multiple internal reflections before engaging the intended diffractive structures. As illustrated in FIGS. 1 and 2, these repeated interactions, sometimes referred to as rebounce events, can lead to uneven coupling efficiency, stray reflections, and reduced overall luminance uniformity. In addition, diffractive optical structures may respond differently to distinct polarization components of the incident light, causing further variations in coupling behavior when the projection optics produce strongly polarized output.

Accordingly, the characteristics of the display light delivered to the waveguide (including its spatial footprint, polarization state, and angular distribution) play a significant role in determining the performance of the overall display system. Systems that rely on polarized microdisplay light and PBS-based illumination architectures may exhibit particularly strong sensitivity to these factors, as the polarization purity and pupil size of the outgoing beam can vary depending on the configuration of upstream optical components. These interactions motivate the use of projection-optical assemblies that can condition or adapt the display light prior to waveguide injection, helping to ensure that the light enters the waveguide in a manner compatible with the thin geometry and diffractive structure placement described above.

FIG. 5 illustrates an optical system 500 configured to condition polarized display light prior to delivery into a waveguide combiner 402 of a head-wearable or near-eye display system. The illustrated optical system 500 includes an illumination module 418, a polarization beam-splitting (PBS) cube 502, a prism assembly 504 having multiple polarization-altering optical surfaces, and a waveguide combiner 402 having an input coupler 404 that receives conditioned display light 406 from the prism assembly 504. Collectively, these components form a projection-optical chain suitable for delivering spatially and polarization-conditioned display light into the thin waveguide substrate, such that injected light propagates with improved efficiency and uniformity.

The illumination module 418 includes, for example, one or more solid-state emitters such as light-emitting diodes (LEDs), vertical-cavity surface-emitting lasers (VCSELs), edge-emitting laser diodes, micro-LED arrays, liquid crystal on silicon (LCoS) panels, laser beam scanning (LBS) modules, or combinations thereof. In at least some embodiments, the illumination module 418 includes red, green, and blue (RGB) emitters configured to provide visible display illumination, although infrared or ultraviolet sources may also be used in alternative configurations. The emitters may be mounted on a ceramic substrate or a printed-circuit board and may include associated optical elements such as collimating lenses, microlens arrays, or diffusers to shape the emitted light prior to entering the PBS cube 502. In some embodiments, the LED or laser output may be conditioned to provide a uniform intensity distribution across the entrance pupil of the PBS cube.

The PBS cube 502 is an optical component comprising, for example, a pair of optically transparent cube halves bonded together with a diagonal beam-splitting interface 506. The cube halves may be fabricated from optical glass such as BK7, fused silica, borosilicate, lanthanum-based glass, or other optical materials having refractive indices suitable for imaging applications. The diagonal PBS interface 506 includes, for example, a multilayer dielectric thin-film stack configured to transmit one polarization state (e.g., p-polarized light) while reflecting the orthogonal polarization state (e.g., s-polarized light). The dielectric layers include, for example, alternating high-index and low-index materials, such as titanium dioxide (TiO₂), tantalum pentoxide (Ta₂O₅), silicon dioxide (SiO₂), aluminum oxide (Al₂O₃), or niobium pentoxide (Nb₂O₅). The thickness and arrangement of these layers are configured to achieve target reflectivity and transmission spectra over the wavelength bands used by the display system.

In at least some embodiments, illumination light 406 from the illumination module 418 first enters the PBS cube 502 through a right-side lens 508. The terms “right-side”, “left-side”, “top”, and “bottom” are used herein with reference to the orientation of the PBS cube 502 as depicted in FIG. 5, and correspond to the faces of the cube as arranged relative to the internal diagonal PBS interface 506 and the optical axes of the system. The right-side lens 508 may be a spherical, aspherical, or freeform refractive element configured to collimate or partially collimate the incident light 406 prior to entering the interior of the cube.

As depicted in FIG. 5, illumination light 406 emitted by the illumination module 418 is illustrated using two representative ray segments 406-1 and 406-2 that emerge from the illumination module and enter the PBS cube 502. In the illustrated embodiment, the first ray segment 406-1 is shown using solid lines, and the second ray segment 406-2 is shown using dashed lines to distinguish the two representative portions of the illumination beam for explanatory clarity. These ray segments 406-1 and 406-2 do not represent different wavelengths or different beam types but instead depict two portions of the same illumination light 406 that follow slightly different geometric paths into the PBS cube 502. Once inside the PBS cube 502, the illumination light 406 (including its representative components 406-1 and 406-3) encounters the diagonal PBS interface 506, where the corresponding polarization components of the illumination light are separated, reflected, or transmitted as described in further detail below.

In the illustrated embodiment of FIG. 5, illumination light 406 emitted by the illumination module 418 is depicted using two representative ray segments 406-1 and 406-2 that enter the PBS cube 502 from the right. For illustration purposes, the ray segment 406-1 is shown using solid lines, and the ray segment 406-2 is shown using dashed lines to distinguish their respective geometric paths. These ray segments do not represent different wavelengths or polarization states of the illumination light 406. Instead, they illustrate two portions of the same illumination beam entering the PBS cube 502 along slightly different trajectories. Once inside the PBS cube 502, the illumination light 406 encounters the diagonal PBS interface 506, where its orthogonal polarization components are separated as described in greater detail below.

A top lens 510 is disposed along the top surface of the PBS cube 502 and serves as an auxiliary optical interface through which one of the polarization components may exit or re-enter the PBS cube 502, depending on its polarization and propagation direction. A left-side lens 512, positioned opposite the right-side lens 508, is configured to condition the modulated, image-bearing light as it exits the cube and enters the prism assembly 504. A liquid-crystal-on-silicon (LCoS) display panel 514 (or another type of microdisplay) is mounted to the bottom surface of the PBS cube 502 and includes an array of liquid-crystal pixels bonded over a reflective silicon backplane. The LCoS panel 514 is configured to modulate incident illumination light 406 by selectively rotating polarization states at each pixel in accordance with image data supplied by associated display driver circuitry.

When the illumination light 406 enters the interior of the PBS cube 502, the diagonal PBS interface 506 separates the light into two orthogonal polarization components, which are represented conceptually in FIG. 5 by the solid-line ray path 501 and the dashed-line ray path 503. In one illustrative configuration, the PBS interface 506 reflects the polarization component corresponding to the solid-line ray path 501 while transmitting the polarization component corresponding to the dashed-line ray path 503. The polarization states of these rays are indicated by the polarization symbols 505 and 507, while the corresponding double-headed arrows 509 and 5011 represent their electric-field orientations. These graphical indicators help illustrate how the PBS cube 502 separates and routes the orthogonal polarization components of the illumination light 406 before the modulated display light is directed toward the prism assembly 504.

The polarized component of the first ray path 501 is reflected downward toward the LCoS panel 514, which modulates its polarization state according to the displayed image content. The modulated component of the first ray path 501 then reflects from the LCoS panel 514 and re-enters the PBS interface 506 with a newly rotated polarization state. Depending on the degree of polarization rotation imparted by the LCoS panel 514 at each pixel, portions of the modulated ray may now be transmitted through the PBS interface 506 toward the left-side lens 512.

The polarized component of the second ray path 503, which passes through the PBS interface 506, may propagate toward the top lens 510 or be redirected within the cube 502, depending on its polarization state and optical path. The polarized component of the second ray path 503 may also interact with the LCoS panel 514 after being redirected by internal reflections or after combining with portions of the polarized component of the first ray path 501 whose polarization has been rotated. As shown in FIG. 5, the PBS cube 502 supports multiple internal ray paths associated with different polarization orientations, each shown with its respective polarization symbol and axis-orientation arrow.

In FIG. 5, these behaviors are depicted by path segments in upper region 516 and lower region 518 of the PBS cube 502, representing the two polarization-dependent optical zones formed by the diagonal PBS interface 506. The PBS cube 502 thus functions both as a beam-splitter and a polarization-management component, routing light to and from the LCoS panel 514 and supplying properly conditioned, image-bearing light to the left-side lens 512 for injection into the prism assembly 504.

The prism assembly 504 receives modulated display light 406 (illustrated as modulated display light 406-3 and 406-4) from the PBS cube 502. The prism assembly 504 may be fabricated from an optically transparent refractive material such as BK7 borosilicate glass, fused silica, polymethyl methacrylate (PMMA), polycarbonate, or cyclic olefin polymers, which provide suitable transmission characteristics across visible and near-infrared wavelength ranges. In at least some embodiments, the material exhibits a refractive index between approximately 1.45 and 1.80, selected to support target internal reflection geometries. The prism assembly 504 includes, for example, three primary surfaces 520, 522, and 524 arranged such that the first surface 520 (S1) and third surface 524 (S3) are substantially parallel to one another, enabling repeated internal passes of light within the prism for polarization mixing and spatial redistribution. The first surface 520 includes, for example, a reflective coating 526, which may be implemented as a metallic mirror (e.g., aluminum, silver, or gold), a dielectric mirror stack (e.g., coating), or a polarization-selective reflective coating. The third surface 524 includes, for example, a polarization beam-splitting coating 528 similar (or different) in configuration to the PBS interface 506 but configured to operate within the refractive environment of the prism. The second surface 522 (S2), in at least some embodiments, is a transmission surface or may include optical coatings such as anti-reflection coatings to reduce Fresnel losses and improve transmission efficiency.

A polarization conversion layer 530, which may be implemented as a half-wave plate (HWP), is positioned on or adjacent to one of the prism surfaces 520, 522, or 524 and precedes the PBS coating 528 on the third surface 524 (e.g., in an optical path prior to the PBS coating 528). The HWP, in at least some embodiments, is constructed from birefringent crystalline materials, such as quartz or sapphire, polymer-based retarders, liquid-crystal retarders, or laminated multilayer retarders configured for broadband half-wave retardance (e.g., λ/2 at wavelengths between 450 nm and 650 nm). The POLARIZATION CONVERSION LAYER 530 rotates the polarization direction of modulated display light 406-3 by twice the angle between the incident polarization axis and the optical axis of the retarder. By placing the POLARIZATION CONVERSION LAYER 530 in front of or along internal optical paths, sequential interactions with the reflective coating 526 and the PBS coating 528 cause repeated polarization rotation and mixing, thereby facilitating controlled depolarization and spatial redistribution.

The combined action of the reflective coating 526, the PBS coating 528, and the polarization conversion layer 530 results in spatial redistribution of rays that would otherwise remain concentrated within a larger exit pupil. This redistribution reduces the effective beam footprint of modulated display light 406-3, 406-4, allowing the outgoing light to better match the thin geometry of the waveguide combiner 402. As an example, the beam footprint may be reduced from, for example, approximately 3-5 millimeters to approximately 0.5-2.5 millimeter, corresponding to thicknesses typical of diffractive waveguide substrates. By reducing polarization purity while preserving etendue, the prism assembly 504 helps mitigate rebounce interactions at the input coupler 404, thereby reducing stray reflections, ghost images, and coupling non-uniformities.

In at least some embodiments, the diagonal PBS interface 506 establishes a first optical reference orientation that defines the polarization-splitting frame within the PBS cube 502. This orientation corresponds to the geometric alignment of the PBS interface 506 and determines how the orthogonal polarization components of the illumination light 406 are separated, reflected, and transmitted inside the cube. By contrast, the output surfaces of the prism assembly 504 establish a second optical reference orientation associated with the direction in which the modulated display light 406-3 exits the prism and propagates toward the input coupler 404 of the waveguide combiner 402. These two optical reference orientations are not physical components of the system but are conceptual frames that assist in describing how the PBS cube 502 and prism assembly 504 operate within different alignment axes. For example, the PBS interface 506 governs polarization routing inside the cube, whereas the prism assembly 504 defines the propagation direction and polarization state of the light delivered into the waveguide 402.

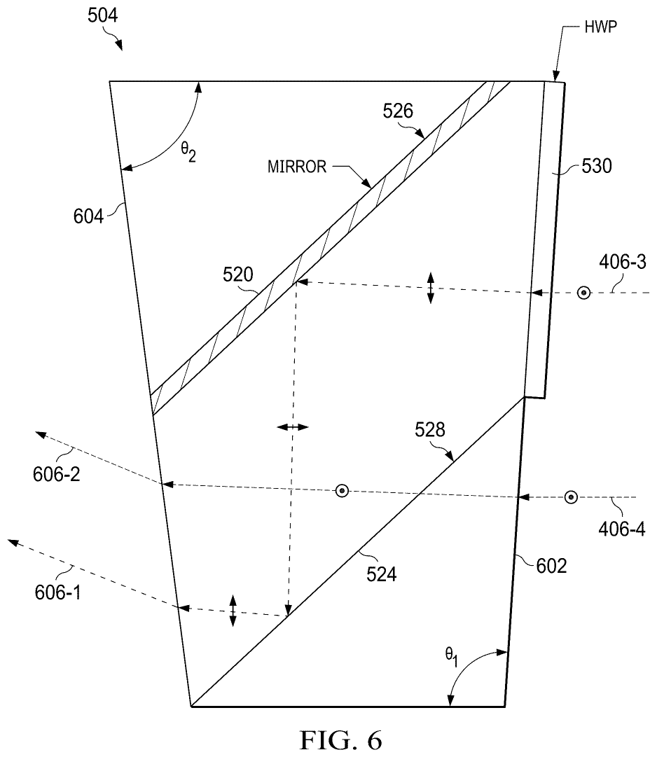

In at least some embodiments, the prism assembly 504 is configured as a turning prism by angling one or more of the surfaces 520, 522, and 524. By adjusting the entrance or exit angles by, for example, 1 degree to 20 degrees, the chief-ray direction of the outgoing modulated display light 406-3, 406-4 may be altered to support binocular alignment in dual-display systems, to provide beam steering for optical see-through architectures, or to accommodate mechanical packaging constraints within compact head-worn devices. Additional details of such turning-prism configurations are provided with reference to FIG. 6.

FIG. 6 illustrates the prism assembly 504 of FIG. 5 configured as a turning prism, according to at least some embodiments. FIG. 6 expands upon the prism assembly 504 introduced in FIG. 5 by illustrating an embodiment in which the prism is configured to provide a controlled deflection of the modulated display light 406-3. Whereas FIG. 5 depicts the internal polarization-mixing and footprint-reduction behavior of the prism assembly 504, FIG. 6 shows how these same internal optical mechanisms may be combined with angled entrance and exit faces to redirect the outgoing display light along a target propagation direction while still maintaining the conditioning functions previously described.

In this embodiment, the prism assembly 504 includes a pair of side surfaces 602 and 604 that function as the entrance and exit faces for the modulated display light 406-3, 406-4 along with internal surfaces corresponding to the first surface 520 and the third surface 524 described above with respect to FIG. 5. These surfaces carry the reflective coating 526 and the polarization beam-splitting coating 528, respectively. The side surfaces 602 and 604 are oriented at non-orthogonal angles relative to the internal surfaces 520 and 524, and the angles between these surfaces are denoted by θ₂ (at the top-left corner) and θ₁ (at the bottom-right corner). By appropriate configuration of θ₁ and θ₂, the prism assembly 504 deflects the chief ray of the incoming modulated display light 406-3, 406-4 to produce conditioned output light 406-5 and 406-6 having a target propagation direction relative to the waveguide combiner 402 and the user's eyebox.

The first surface 520 of the prism assembly 504 carries a reflective coating 526, which may be implemented as a metallic mirror (for example, aluminum, silver, or gold), a dielectric mirror stack, or a polarization-selective reflective coating as described above. The third surface 524 carries a polarization beam-splitting coating 528, configured to transmit one polarization component of the incident light while reflecting at least a portion of the orthogonal polarization component. The side surfaces 602, 604 may be uncoated transmission faces, or may include anti-reflection coatings to reduce Fresnel losses when the modulated display light 406-3, 406-4 enters and the conditioned display light 406-5, 406-6 exits the prism assembly 504. In the illustrated embodiment, the first surface 520 and third surface 524 are substantially parallel, forming a wedge geometry with the entrance surface 602 and side surface 604 (acting as an exit surface) that supports controlled internal reflections and polarization-dependent routing.

A polarization conversion layer 530, such as an HWP, is positioned adjacent to the entrance surface 602 along the path of the modulated display light 406-3, 406-4. As the modulated display light 406-3, 406-4 enters the prism assembly 504 through the side surface 602 and passes through the POLARIZATION CONVERSION LAYER 530, the polarization conversion layer 530 rotates the polarization state of the light according to the relative orientation between the incident polarization axis and the optical axis of the retarder. The rotated polarization state is schematically illustrated in FIG. 6 by polarization symbols and double-headed arrows, which indicate the polarization orientation of the modulated display light 406-3, 406-4 at various locations along its internal path.

In one illustrative trajectory shown in FIG. 6, the modulated display light 406-3, 406-4 enters the prism assembly 504 through the right-hand side surface 602, passes through the polarization conversion layer 530, and propagates horizontally toward the first surface 520. Upon reaching the reflective coating 526 on the first surface 520, the light is reflected downward and then travels toward the third surface 524. When this light reaches the polarization beam-splitting coating 528 on the third surface 524, the portion of the light whose polarization is aligned with the transmission axis of the coating 528 is transmitted through the third surface 524 and exits the prism assembly 504 as conditioned display light 406-5, 406-6, propagating in a deflected direction toward the waveguide combiner 402. Depending on the design of the coating 528 and the incident polarization state set by the POLARIZATION CONVERSION LAYER 530, another portion of the light may be reflected by the coating 528 and directed out of the prism assembly 504 at a different angle (e.g., a different propagation direction), as schematically illustrated by the additional arrow emerging from the lower-left region of the prism in FIG. 6.

The combined effect of the entrance and exit angles θ₁ and θ₂, the parallel relationship between surfaces 520 and 524, the reflective coating 526, the polarization beam-splitting coating 528, and the polarization conversion layer 530 allows the prism assembly 504 to both deflect and condition the modulated display light 406-3, 406-4. In some embodiments, θ₁ and θ₂ are selected such that the chief-ray direction of the outgoing display light 406-5, 406-6 is rotated by, for example, approximately 1 degree to 20 degrees relative to the direction of the incoming display light 406-3. This controlled deflection can be used to provide binocular overlap in dual-eye displays, to direct the output beam toward a desired user interface region in monocular eyewear, or to route the light around mechanical structures within a compact head-worn form factor. At the same time, the internal polarization mixing and multiple-pass behavior described with respect to FIG. 5 can be preserved or tuned in the turning-prism configuration of FIG. 6, such that the output light 406-5, 406-6 remains depolarized or partially depolarized and exhibits a reduced footprint well matched to the input coupler 404 of the waveguide 402.

The prism assemblies illustrated in FIG. 5 and FIG. 6 thus enable multiple optical benefits within compact projection systems for head-wearable and near-eye displays. By combining polarization rotation, polarization-dependent reflection and transmission, and controlled geometric deflection within a single prism structure, the designs can reduce the effective beam footprint of modulated display light 406-3, 406-4 mitigate rebounce interactions at the waveguide input coupler 404, accommodate target chief-ray directions, and maintain etendue compatibility with thin waveguide substrates. These characteristics allow the projection optics to deliver conditioned display light more efficiently and with fewer stray-light artifacts, supporting improved optical uniformity, enhanced image quality, and flexible mechanical integration in a wide range of wearable display configurations.

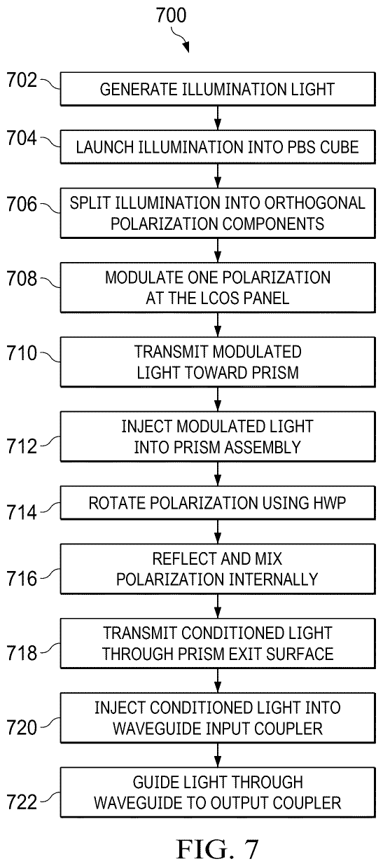

FIG. 7 illustrates a flow diagram of an example method 700 for conditioning display light prior to injection into a waveguide combiner of a head-wearable or near-eye display system. The operations shown in the method 700 correspond to the optical components and embodiments described above, including FIGS. 1 through 6. For purposes of illustration, the method 700 is described in the context of an implementation in which illumination light 406 is generated by an illumination module 418, polarization-separated and modulated within a PBS cube 502 incorporating an LCoS panel 514, and subsequently conditioned by a prism assembly 504 before being injected into a waveguide combiner 402. In other embodiments, the method 700 may be performed using alternative optical elements, integrated illumination systems, or different projection-engine architectures. Furthermore, the method 700 is not limited to the particular ordering of operations depicted in FIG. 7, as at least some operations may be executed in parallel, combined into composite operations, or performed in a different sequence, and in at least some embodiments, the method 700 may include additional operations beyond those explicitly depicted.

At block 702, the method 700 includes generating illumination light 406 using the illumination module 418. The illumination module 418 may include one or more light-emitting elements, such as LEDs, VCSELs, edge-emitting laser diodes, micro-LED arrays, or combinations thereof, and may include collimating or beam-shaping optics to form a desired illumination profile suitable for subsequent polarization splitting and modulation. At block 704, the illumination light 406 is launched into the PBS cube 502, for example, through a right-side lens configured to direct the illumination light into the interior of the cube. In some embodiments, representative ray segments of the illumination light 406 may be illustrated to depict differing geometric paths entering the PBS cube 502.

At block 706, the illumination light 406 is split into orthogonal polarization components by the diagonal PBS interface 506 within the PBS cube 502. In one configuration, a first polarization component is reflected toward the LCoS panel 514, while the orthogonal polarization component is transmitted through the PBS interface for further routing within the cube. At block 708, one of the polarization components is modulated at the LCoS panel 514. The LCoS panel 514 includes liquid-crystal pixels configured to rotate polarization states according to image data, such that the reflected light from the LCoS panel 514 carries pixel-level image modulation.

At block 710, the modulated polarization component is transmitted back through the PBS interface 506 toward the prism assembly 504. In this stage, the polarization rotation induced by the LCoS panel 514 aligns the modulated display light with the transmission axis of the PBS interface 506.

At block 712, the method includes injecting the modulated display light into the prism assembly 504 through an entrance face. The prism assembly 504 receives the modulated light and directs it along internal optical paths for further conditioning. At block 714, the method includes rotating the polarization of the modulated display light using a polarization-conversion layer, such as a polarization conversion layer 530, positioned within or adjacent to the prism assembly 504. The polarization rotation prepares the light for subsequent polarization-dependent reflection or transmission at internal surfaces of the prism.

At block 716, the modulated display light undergoes internal reflections and polarization mixing within the prism assembly 504. In the illustrated embodiment, internal reflections occur at surfaces that include a reflective coating 526 and a polarization beam-splitting coating 528, enabling spatial redistribution and controlled depolarization of the modulated display light. At block 718, conditioned display light exits the prism assembly 504 through an exit surface, such as the third surface 524, after transmission through the polarization-dependent coating 528. The resulting output light may exhibit reduced spatial footprint, redistributed polarization characteristics, and improved compatibility with the input coupler 404 of a waveguide combiner.

At block 720, the conditioned display light is injected into the waveguide input coupler 404. The input coupler 404 directs the conditioned light into the waveguide combiner 402 for propagation through the waveguide substrate. At block 722, the method includes guiding the conditioned display light through the waveguide toward an output coupler, which directs the light into the eye of the user. The propagation may include total internal reflection, partial internal reflection, or combinations thereof, depending on the design of the waveguide combiner.

As shown in FIG. 7, the method 700 provides a sequence of optical conditioning operations that improve the spatial and polarization characteristics of the display light before waveguide injection. By integrating illumination generation, polarization splitting, pixel-level modulation, polarization rotation, internal prism reflections, and polarization-selective transmission, the method 700 enables more efficient coupling of image-bearing light into thin waveguide substrates while reducing stray reflections, rebounce artifacts, and non-uniformities in the displayed imagery.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified, and all such variations are considered within the scope of the disclosed subject matter. Accordingly, the protection sought herein is set forth in the claims below.

What is claimed is:

1. A prism assembly comprising:
a prism having a plurality of internal surfaces, including a first internal surface and a second internal surface;
a reflective coating disposed on the first internal surface;
a polarization beam-splitting coating disposed on the second internal surface; and
a polarization-conversion layer disposed within or adjacent to the prism such that display light propagating within the prism passes through the polarization-conversion layer prior to interacting with the polarization beam-splitting coating.

2. The prism assembly of claim 1, wherein the first internal surface and the second internal surface are parallel to one another.

3. The prism assembly of claim 1, wherein the polarization-conversion layer comprises a waveplate.

4. The prism assembly of claim 1, wherein the reflective coating comprises at least one of:
a metallic mirror coating;
a dielectric mirror coating; or
a polarization-selective reflective coating.

5. The prism assembly of claim 1, wherein the polarization beam-splitting coating is configured to transmit one polarization component of the display light and reflect at least a portion of an orthogonal polarization component.

6. The prism assembly of claim 1, further comprising an entrance surface and an exit surface through which the display light respectively enters and exits the prism.

7. The prism assembly of claim 6, wherein the entrance surface and the exit surface are oriented relative to the internal surfaces such that display light exiting the prism is redirected along a different propagation direction than display light entering the prism.

8. The prism assembly of claim 1, wherein the prism is configured to cause display light propagating within the prism to undergo repeated internal passes between the first internal surface and the second internal surface.

9. The prism assembly of claim 8, wherein the prism is configured such that the repeated internal passes of the display light within the prism cause polarization mixing or spatial redistribution of the display light.

10. A display system comprising:
an illumination module configured to generate display light;
a waveguide; and
an optical system positioned between the illumination module and the waveguide, the optical system comprising:
a prism assembly having a plurality of internal surfaces, including a first internal surface and a second internal surface;
a reflective coating disposed on the first internal surface;
a polarization beam-splitting coating disposed on the second internal surface; and
a polarization-conversion layer disposed within or adjacent to the prism assembly such that display light propagating within the prism assembly passes through the polarization-conversion layer prior to interacting with the polarization beam-splitting coating,
wherein the prism assembly is configured to direct the display light toward the waveguide.

11. The display system of claim 10, wherein the prism assembly further comprises an entrance surface through which the display light enters the prism assembly and an exit surface through which conditioned display light exits the prism assembly.

12. The display system of claim 10, wherein the first internal surface and the second internal surface of the prism assembly are parallel to one another.

13. The display system of claim 10, wherein the polarization-conversion layer comprises a waveplate.

14. The display system of claim 10, wherein the reflective coating comprises at least one of:
a metallic mirror coating;
a dielectric mirror coating; or
a polarization-selective reflective coating.

15. The display system of claim 10, wherein the polarization beam-splitting coating is configured to transmit one polarization component of the display light and reflect at least a portion of an orthogonal polarization component.

16. The display system of claim 10, wherein the prism assembly comprises an entrance surface and an exit surface through which the display light respectively enters and exits the prism assembly.

17. The display system of claim 16, wherein the entrance surface and the exit surface are oriented relative to the internal surfaces such that display light exiting the prism assembly is redirected along a different propagation direction than display light entering the prism assembly.

18. The display system of claim 10, wherein the prism assembly is configured to cause display light propagating within the prism assembly to undergo repeated internal passes between the first internal surface and the second internal surface.

19. The display system of claim 18, wherein the prism assembly is configured such that the repeated internal passes of the display light within the prism assembly cause polarization mixing or spatial redistribution of the display light.

20. A method of operating a display system, comprising:
generating display light using an illumination module;
directing the display light toward a prism assembly having a plurality of internal surfaces including a first internal surface with a reflective coating, a second internal surface with a polarization beam-splitting coating, and a polarization-conversion layer disposed within or adjacent to the prism assembly;
propagating the display light within the prism assembly such that the display light interacts with the reflective coating and the polarization beam-splitting coating and passes through the polarization-conversion layer; and
coupling conditioned display light from the prism assembly into an input coupler of a waveguide.
